(19) United States
(12) Patent Application Publication
(10) Pub. No.: US 2012/0262682 A1
(43) Pub. Date: Oct. 18, 2012

(54) PROJECTION DEVICE WITH AN ILLUMINATION LAMP

(75) Inventors: PING-YANG CHUANG, Tu-Cheng (TW); WEI-FENG WU, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/158,475

(22) Filed: Jun. 13, 2011

(30) Foreign Application Priority Data
Apr. 18, 2011 (CN) 201110096669.1

(51) Int. Cl. G03B 21/20

(52) U.S. Cl. 353/119

(57) ABSTRACT

A projection device includes a base, a desk lamp, a projector, a supporting member, and a fastener assembly. The desk lamp defines a first hole. The projector defines a second hole aligned with the first hole of the desk lamp. One end of the supporting member is connected to the base, and another end of the supporting member is connected to the desk lamp. The fastener assembly includes a bolt and a nut. The nut is fixed in the projector. The bolt is capable of passing through the first hole and being screwed into the nut via the second hole to connect the projector to the desk lamp.

### BACKGROUND

1. Technical Field

The present disclosure relates to projection devices and, particularly, to a projection devices having an illumination lamp.

2. Description of Related Art

Generally, projectors are best used in darkened rooms. However, operating a projector in a dark room is difficult because it is difficult to see the controls, and if the projector is connected to a computer it is difficult to use the computer in the darkness as well.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a projection device in accordance with an exemplary embodiment.

FIG. 2 is an isometric view of the projection device of FIG. 1 from another perspective and with a portion of a supporting member omitted to reveal an interior portion of the projection device.

FIG. 3 is an exploded view of the circled portion III of FIG. 1.

FIG. 4 is similar to FIG. 3, but viewing from another perspective.

FIG. 5 is a cross-sectional view taken along line V-V of FIG. 2.

### DETAILED DESCRIPTION

Embodiments of the present disclosure are now described in detail, with reference to the accompanying drawings.

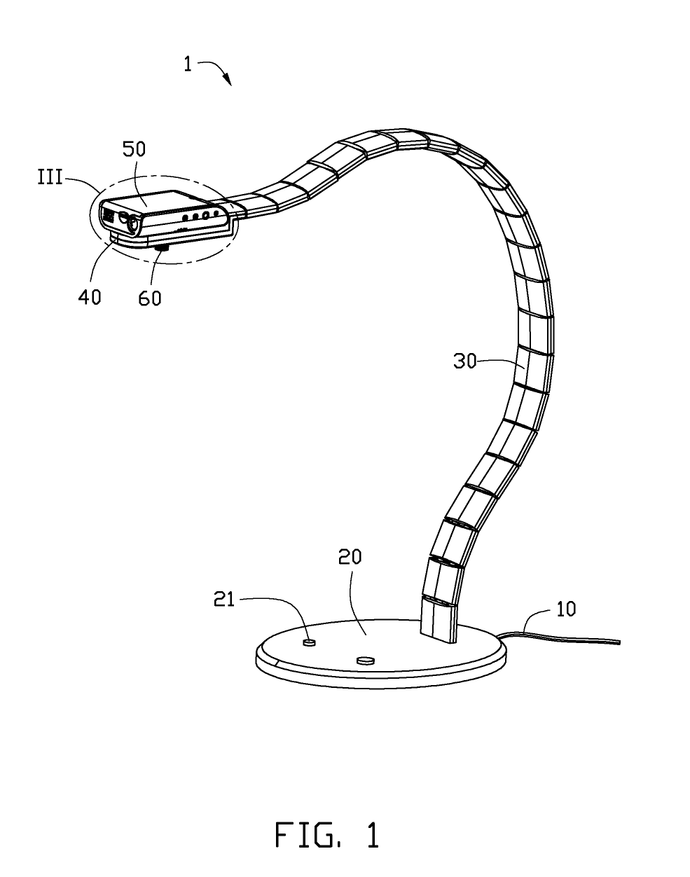

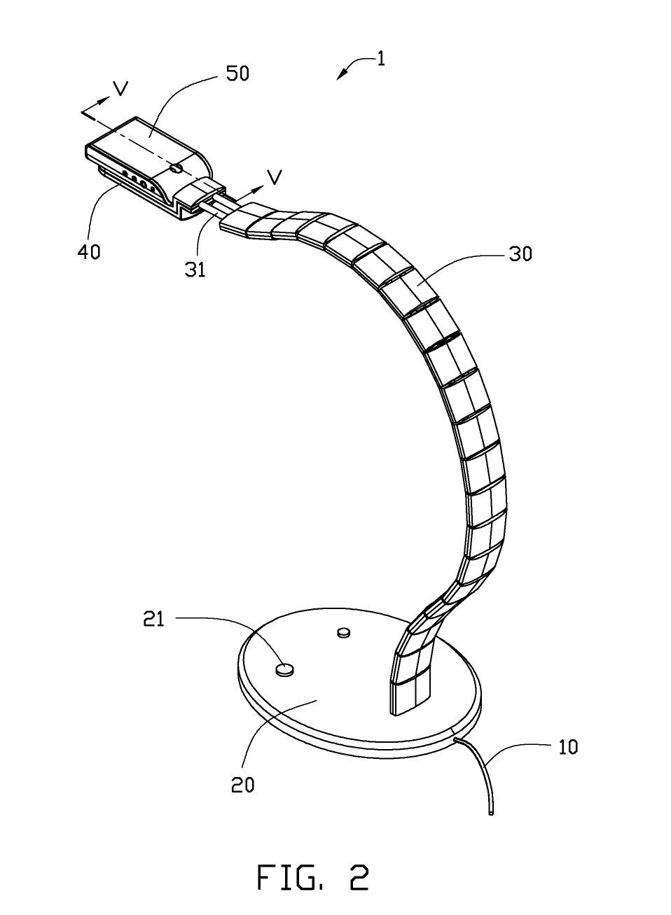

Referring to FIGS. 1-2, a projection device 1 includes a wire 10, a base 20, a supporting member 30, a desk lamp 40, a projector 50, and a fastener assembly 60.

The wire 10 extends from the base 20. One end of the wire 10 includes a plug to couple with a socket, thereby making an electrical connection between the projection device 1 and a power source (not shown). One end of the supporting member 30 is connected to the base 20, and the opposite end of the supporting member 30 is connected to the desk lamp 40. The projector 50 is fixed to the desk lamp 40 through the fastener assembly 60. The projection device 1 is able to provide desktop illumination with the desk lamp 40 while at the same time project images onto a projection surface (not shown) with the projector 50.

The base 20 includes two switches 21. Each switch 21 is connected to the wire 10. In the embodiment, the two switches 21 are connected in parallel and can respectively turn on/off the desk lamp 40 and the projector 50.

The supporting member 30 is flexible. The supporting member 30 can be twisted and/or bent and can maintain the twisted/bent orientation, to easily aim the projector 50 toward a desired projection surface, even upward toward the ceiling or down toward a desktop. In the embodiment, the supporting member 30 comprises a flexible conduit (not labeled).

Two cables 31 extend through the supporting member 30. First ends of the cables 31 are respectively connected to the switches 21, and the opposite ends are respectively connected to the desk lamp 40 and the projector 50.

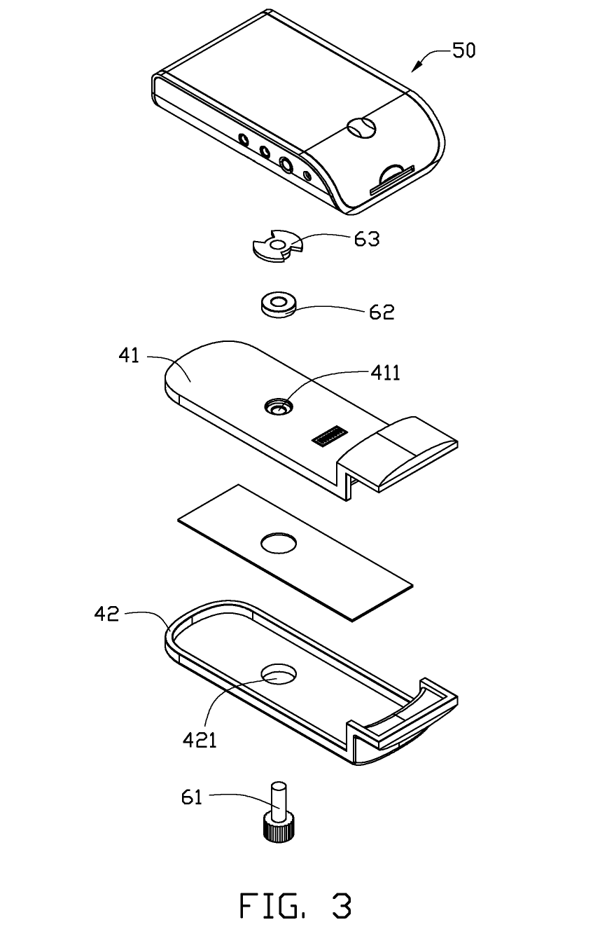

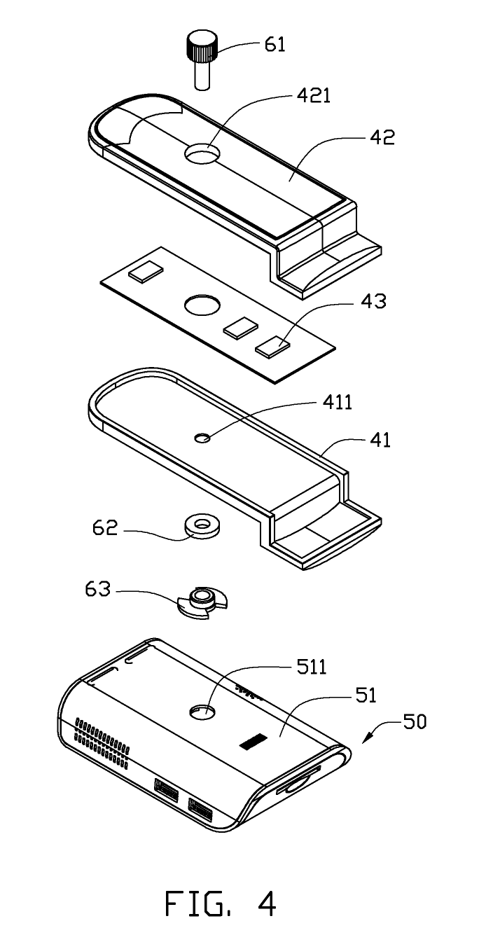

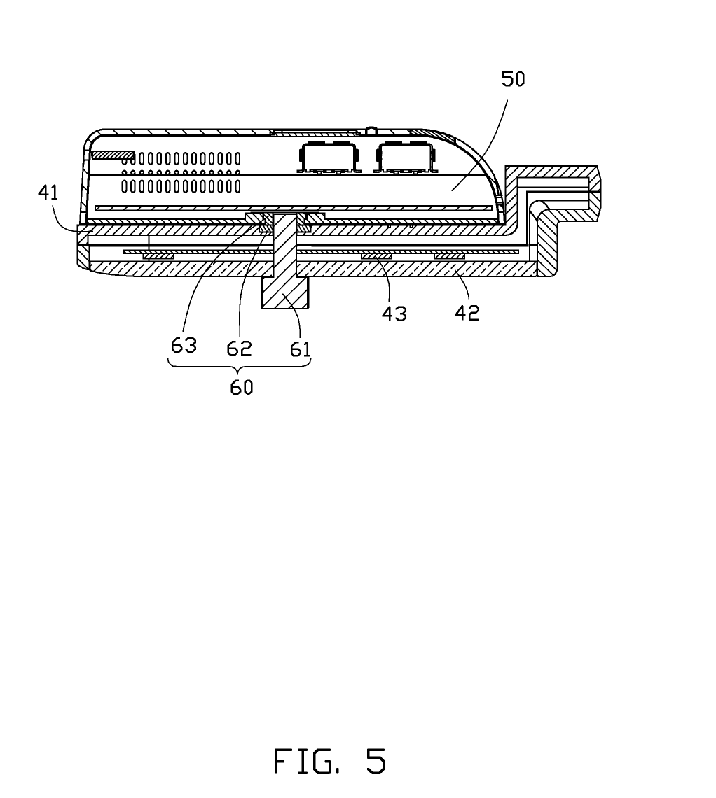

Referring to FIGS. 3-5, the desk lamp 40 includes a first cover 41, a second cover 42, and a number of light emitting diodes (LEDs) 43. The first cover 41 and the second cover 42 cooperatively define a receiving space 44 to receive the LEDs 43 and a printed circuit board (PCB) (not labeled). The first cover 41 and the second cover 42 respectively define a through hole 411, 421. The through hole 411 and the through hole 421 are aligned with each other. In the embodiment, the second cover 42 is made of transparent material, thereby allowing the light emitted from the LEDs 43 to pass therethrough.

The projector 50 is arranged on the desk lamp 40. A casing 51 of the projector 50 defines a through hole 511 aligned with the through holes 411, 421 of the covers 41, 42. In other embodiments, the projector 50 may further include an independent power source, such as a battery, to provide power to the projector 50, so that the projector 50 can be separated from the desk lamp 40 and used elsewhere.

The fastener assembly 60 includes a bolt 61, a washer 62, and a nut 63. The washer 62 is fixed to the top surface of the casing 51 to protect the top surface of the casing 51 from being damaged by the nut 63. The bolt 61 can be extended through the washer 62 and screwed into the nut 63, thereby fixing the desk lamp 40 to the projector 50. When needed, the bolt 61 can be turned to disengage from the nut 63, enabling the projector 50 to be detached from the desk lamp 40.

In that way, the projection device 1 can project on desired areas. The user do not need an extra lamp to provide illumination when needing to input information.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A projection device comprising:
a base;
a desk lamp defining a first hole;
a projector defining a second hole aligned with the first hole of the desk lamp;
a supporting member comprising one end connected to the base, and another end connected to the desk lamp; and
a fastener assembly comprising a bolt and a nut, the nut being fixed in the projector, the bolt passing through the first hole and being screwed into the nut via the second hole, thereby connecting the projector to the desk lamp.

2. The projection device as described in claim 1, wherein the supporting member is flexible.

3. The projection device as described in claim 1, further comprising a wire and two cables, wherein the wire extends from the base, the base further comprises two switches, each of the switches is connected to the wire, the supporting member is hollow, the two cables extend through the supporting member, first ends of the cables are respectively connected to the one of the switches, the opposite ends of the cables are respectively connected to the desk lamp and the projector.

4. The projection device as described in claim 1, wherein the desk lamp comprises a first cover, a second cover and a plurality of LEDs, the first cover and the second cover defines a receiving space to receive the LEDs, the second cover is made of transparent material, allowing the light emitted by the LEDs to pass therethrough.
